(19) United States
(12) Patent Application Publication
(10) Pub. No.: US 2001/0017182 A1
(43) Pub. Date: Aug. 30, 2001

(54) Method of preventing roping phenomenon of bonding paste for bonding die on lead frame

(76) Inventor: Mitsuhiro Takahashi, Yamagata (JP)

Correspondence Address: Paul J. Esatto, Jr., Scully, Scott, Murphy & Presser, 400 Garden City Plaza, Garden City, NY, 11530, US

(21) Appl. No.: 09/741,322

(22) Filed: Dec. 20, 2000

(30) Foreign Application Priority Data
Dec. 20, 1999 (JP) 11-360703

(51) Int. Cl. B32B 31/16

(52) U.S. Cl. 156/73.1

(57) ABSTRACT

A lead frame is conveyed on a lead frame conveying rail to a bonding paste coating stage. When the lead frame reaches the bonding paste coating stage, a cylinder containing a paste therein is lowered and the bonding paste is applied in a point-like fashion to an island portion of the lead frame on which a die is bonded. When the application of the bonding paste in a point like fashion is completed, the cylinder is lifted. An ultrasonic vibration generating device is provided directly below the lead frame at the bonding paste coating. The ultrasonic vibration generated device is operated during the application process of the bonding paste to contact into with the understand of the lead frame to apply ultrasonic vibration to it.

### BACKGROUND OF THE INVENTION

1. Field of the Invention

The present invention relates to a method of applying bonding paste to a lead frame.

2. Description of the Related Art

In general, a fabrication process for fabricating semiconductor devices includes a step of die bonding in which a semiconductor chip is fixed to a lead frame, a step of wire bonding, and a step of encapsulating the semiconductor chip in a shell with resin, or the like. When semiconductor components are subjected to these processes, lead frames are sequentially conveyed on a conveying-belt system. For example, Japanese Patent Publication No. 39227/92 discloses a lead frame conveying system in which lead frames are conveyed by guiding rails and each of the fabrication processes is carried out on the conveyor-belt system.

A method of applying bonding paste on the lead frame in the die bonding process will hereinafter be described with reference to FIG. 1. FIG. 1A is a schematical diagram showing a bonding paste application stage and a die bonding stage as viewed from one side of the conveyor-belt system, and FIG. 1B is a plan view of thereof.

As shown in the figures, lead frame 23 is conveyed by rails 25 for conveying the lead frame. When the lead frame reaches the paste application stage, bonding paste 22 is applied in a point-like fashion from cylinder 21 in bonding paste applying device 20 for die bonding, to island portion 27 on which a die is mounted by bonding. Lead frame 23 is then conveyed to the adjacent die bonding stage, where die 24 is mounted by bonding. Thereafter, the lead frame is conveyed to the next stage (not shown).

In the bonding paste application stage described above, after bonding paste is applied to the lead frame, cylinder 21 is lifted so as to bring the cylinder apart from the upper surface of the lead frame. At this time, due to the viscosity of the bonding paste, roping phenomenon 28 may occur.

For this reason, the lead frame cannot be conveyed to the next stage until the roping phenomenon of the paste ends. As a result, it takes a long time to accomplish the paste application process.

Further, if the lead frame is conveyed to the next working stage before the roping phenomenon of the paste ends, the roping thread extends between lead frames, causing unsatisfactory electric insulation between the lead frames and a short circuit between the lead frame and the surface of a die that is mounted on the lead frame.

### SUMMARY OF THE INVENTION

It is an object of the present invention to provide a method of preventing occurrence of the roping phenomenon of bonding paste.

In order to achieve the object, according to the present invention, ultrasonic vibration is applied to the lead frame from the underside thereof when it is located at the paste application stage.

Accordingly, the roping phenomenon can be prevented when the applied bonding paste is spread on the island portion, and thus an electric insulation is assured between the lead frames and a short circuit is prevented between the lead frame and the surface of a die that is mounted on the lead frame.

Furthermore, since it becomes possible to obviate the time it takes for the roping phenomenon to end, the paste application process can be carried out in a shorter period of time.

Moreover, since the ultrasonic vibration promotes spreading of the bonding paste, the effective area of adhesion by the bonding paste on the back face of the die can be increased.

The ultrasonic vibration may be applied in the following manner. That is, an ultrasonic vibration generating device is provided at the bonding paste application stage so as to contact into contact with the underside of the lead frame and apply ultrasonic vibration to the lead frame through the underside thereof.

The above and other objects, features and advantages of the present invention will become apparent from the following description with reference to the accompanying drawings which illustrate an example of the present invention.

### BRIEF EXPLANATION OF THE DRAWINGS

FIG. 1 is a diagram illustrative of a bonding paste application stage and a die bonding stage of a conventional semiconductor fabrication conveying system; and

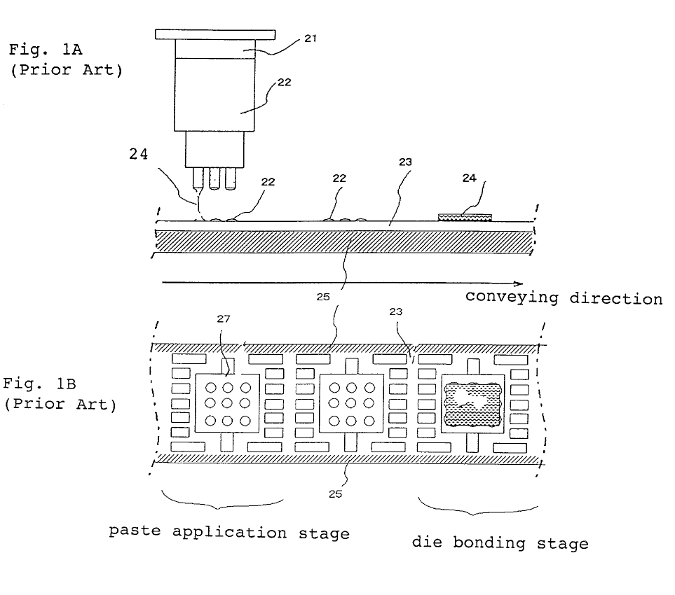

FIG. 2 is a diagram illustrative of a bonding paste coating stage and a die bonding stage of a semiconductor fabrication conveying system including an ultrasonic vibration generating device according to the present invention.

### DETAILED DESCRIPTION OF A PREFERRED EMBODIMENT

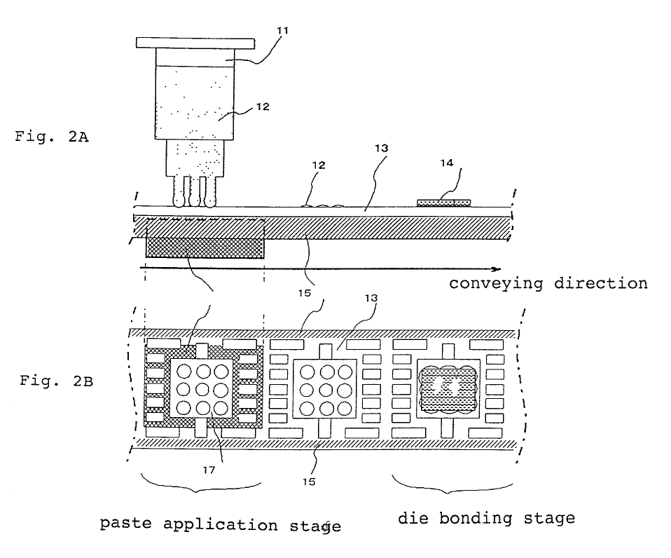

Referring now to FIG. 2, there is provided a ultrasonic vibration generating device 16 at the bonding paste application stage in the semiconductor fabrication system such that it comes into contact with the underside of lead frame 13. Lead frame 13 is conveyed to the paste application stage by means of lead frame conveying rails 15. When lead frame 13 reaches the paste application stage, cylinder 11 containing a paste therein is lowered to island portion 17 of lead frame 13 and applies bonding paste 12 on island portion 17 in a point-like fashion. After applying bonding paste 12 on island portion 17, cylinder 11 is lifted. During the application of the bonding paste, ultrasonic vibration generating device 16 is operated so as to apply ultrasonic vibration to lead frame 13 for about 0.5 second.

Thereafter, lead frame 13 is conveyed to the next stage, or the die bonding stage, in the same manner as in the conventional process. When the lead frame reaches the die bonding stage, die 14 is bonded on the island portion of lead frame 13 and then lead frame 13 is conveyed to the next stage (not shown).

Accordingly, the roping phenomenon due to the viscosity of the bonding paste is prevented. Further, since the ultrasonic vibration promotes spreading of the bonding paste, the effective area of adhesion by the bonding paste on the back face of the die can be increased.

While a preferred embodiment of the present invention has been described using specific terms, such description is for illustrative purposes only, and it is to be understood that changes and variations may be made without departing from the spirit or scope of the following claims.

What is claimed is:

1. A method of preventing roping phenomenon of bonding paste from occurring when the bonding paste is applied to a lead frame on a paste coating stage in a point-like fashion from a cylinder in which paste is reserved, the lead frame being conveyed on a lead frame conveyer, said method comprising the step of:
applying ultrasonic vibration to the lead frame from the underside thereof when it is located at the paste application stage.

2. A method according to claim 1, wherein an ultrasonic vibration generating device is provided at the underside of the lead frame when it is located at the paste application stage, and the ultrasonic vibration generating device is brought into contact with the underside of the lead frame so that the ultrasonic vibration is applied to the lead frame.

3. A method according to claim 2, wherein the underside of the lead frame to which the ultrasonic vibration is applied when the lead frame is located at the paste application stage corresponds to an island portion of the lead frame on which a die is bonded.

4. A method according to claim 3, wherein the ultrasonic vibration is continuously applied to the underside of the island portion during the lift of the cylinder for applying the paste to the island portion in a point-like fashion from the upper surface of the island portion.
